(19) United States
(12) Patent Application Publication
(10) Pub. No.: US 2012/0002198 A1
(43) Pub. Date: Jan. 5, 2012

(54) WAVELENGTH-TUNABLE SPECTROMETER AND WAVELENGTH TUNING METHOD THEREOF

(76) Inventors: Jhin Sup Jhung, Seoul (KR); Young Soo Son, Gyeonggi-do (KR); Byoung Min Kim, Gyeonggi-do (KR)

(21) Appl. No.: 13/062,167

(22) PCT Filed: Jun. 8, 2009
(86) PCT No.: PCT/KR2009/003062

§ 371 Date: May 2, 2011

(30) Foreign Application Priority Data
Sep. 3, 2008 (KR) 10-2008-0086985

(51) Int. Cl. G01J 3/40; G01J 3/28; G02B 5/28

(52) U.S. Cl. 356/305; 356/328

(57) ABSTRACT

This invention relates to a wavelength tunable spectrometer and a wavelength tuning method thereof, and more particularly to a wavelength tunable spectrometer and a wavelength tuning method thereof which are capable of providing the highest efficiency of wavelength of applied light without replacement of a diffraction grid or without operation of an observed portion. According to embodiments of the present invention, since a spectrum of incident light can be obtained with the optimal diffraction efficiency based on a wavelength of the incident light without motion of a camera for observation and replacement of a diffractor by rotatably arranging a transmission type diffractor to provide an incidence angle to provide the optimal efficiency for a selected wavelength of an external light source to be observed and arranging a mirror to provide light, which is changed in its diffraction angle depending on rotation of the transmission type diffractor and the wavelength of the incident light, on the same output light path irrespective of a change in the rotation of the transmission type diffractor and the wavelength of the incident light, it is possible to reduce a size of the spectrometer, product cost and possibility of failure.

### CROSS-REFERENCE TO RELATED APPLICATION

This application claims the benefit of Korean Application No. 10-2008-0086985, filed on Sep. 3, 2008, with the Korean Intellectual Property Office, the disclosure of which is incorporated herein by reference.

### TECHNICAL FIELD

This invention relates to a wavelength tunable spectrometer and a wavelength tuning method thereof, and more particularly to a wavelength tunable spectrometer and a wavelength tuning method thereof which are capable of providing the highest efficiency of wavelength of applied light without replacement of a diffraction grid or without operation of an observed portion.

### BACKGROUND ART

Advance of optic technologies has have an effect on a variety of industries and has built the next generation extensive technologies ranging from micromachining to high speed communications. In particular, micromachining and surface modification techniques, scalpel and targeted cell removal techniques, techniques for reproducing data using an optical medium, ultra high speed communication techniques using total reflection of fiber optics, microscopic techniques for detecting a structure of nano-sized cubic samples, optical techniques incorporated into industries and medical technologies, and so on, all of which use a laser having high straightness, have grown in importance.

In particular, a spectrometer or a monochrometer (hereafter collectively referred to spectrometer) serves to decompose an electromagnetic wave depending on a wavelength difference and specify a distribution of intensity and is generally intended to encompass apparatuses for analyzing particle beams including electron rays as well as electromagnetic waves. In particular, spectroscopy using such a spectrometer is important as a material research means since information on arrangement and motion of electrons and atomic nucleuses in materials can be obtained from spectrum observation using the spectrometer. Such a spectrometer can use x-rays, gamma rays, microwaves and so on in addition to light and thermal energy which is well known in the art.

Simple utilization of this spectrometer is to irradiate a sample with a light source having a particular wavelength, obtain light passing through the sample and observe a wavelength of the light. That is, this is to measure a spectrum of light emitted or absorbed by the sample to detect information on the sample.

FIG. 1 shows a structure of a spectrometer using a typical diffractor. As shown, the spectrometer includes an input slit 2 into which light from a light source 1 having a preset wavelength band is incident, a collimating lens 3 which converts light passing through the input slit 2 into parallel light, a reflection type diffractor 4 which diffracts light passing through the collimating lens 3 based on a wavelength of the light, a mirror 5 which reflects the diffracted light to set a path of the diffracted light, a condensing lens 6 which condenses light reflected by the mirror 5, and a camera 7 which obtains an image to visually analyze light condensed by the condensing lens 6. Here, the collimating lens 3 and the condensing lens 6 may be replaced with a reflection type concave mirror (Czerny-Turner configuration) and a output slit to select a selective wavelength may be formed in the previous state of the camera 7.

The general diffraction type spectrometer provides a spectrum of incident light using the reflection type diffractor 4. Such a reflection type diffractor 4 can be used for only a single band wavelength since it has a fixed diffraction angle depending on a wavelength band of the incident light.

FIG. 2 shows an example wavelength tunable spectrometer configured to cope with a plurality of wavelength, which is an improvement of the spectrometer of FIG. 1. As shown, the wavelength tunable spectrometer includes a rotatable reflection type diffractor 14 into which light passing through the input slit 2 and the collimating lens 13 is incident through a mirror 15, and a rotating observation unit 18 which moves to a path of light reflected by the reflection type diffractor 14, condenses the light and obtains an image to be analyzed. The rotating observation unit 18 includes a condensing lens 16 and a camera 17 and is rotated by double an angle at which the reflection type diffractor 14 is moved, on the basis of the rotation center of the diffractor 14 so that the condensing lens 16 and the camera 17 can move to a path of the diffracted light changed by the reflection type diffractor 14. Although this configuration has a good optical characteristic, this configuration is rarely used since the camera 17, which is large-sized and specialized for the spectrometer, and the condensing lens 16 have to rotate over a wide region, which results in increase of size of the spectrometer, high costs, and low precision due to abrasion by physical driving.

In the meantime, the reflection type diffractors 4 and 14 using the example spectrometer have a non-linear diffraction efficiency profile as shown in FIG. 3 and provide the maximum value of absolute efficiency amounting to just 70% or so, which results in lowering the total efficiency of the spectrometer.

In recent years, researches on wavelength tuning using a transmission type diffractor instead of the reflection type diffractor have been progressed; however, configuration using such a transmission type diffractor still has a problem of large size and high cost since it also uses the configuration shown in FIG. 2.

Accordingly, there is a keen need for a wavelength tunable spectrometer and a wavelength tuning method for providing high diffraction efficiency with a bulky camera fixed, while minimizing a volume of a driving unit, which are capable of coping with various wavelengths to allow high performance spectrum analysis.

### DISCLOSURE

### Technical Problem

To overcome the above problems, it is an object of the present invention to provide a wavelength tunable spectrometer and wavelength tuning method which is capable of providing the optimal diffraction efficiency based on a wavelength of incident light and maintaining an optical path for observation by rotatably arranging a transmission type diffractor to provide an incidence angle to provide the optimal efficiency for a selected wavelength and arranging a mirror to provide light, which is changed in its diffraction angle depending on rotation of the transmission type diffractor and the wavelength of the incident light, on the same output light path irrespective of a change in the rotation of the transmission type diffractor and the wavelength of the incident light.

It is another object of the present invention to provide a wavelength tunable spectrometer and wavelength tuning method which is capable of selecting a diffraction grid arrangement angle of a transmission type diffractor to allow a design of a desired optical path with the optimal efficiency maintained, which results in a high degree of freedom of design for a spectrometer and reduced volume of the spectrometer.

It is still another object of the present invention to provide a wavelength tunable spectrometer and wavelength tuning method which is capable of automatically setting diffraction efficiency of incident light selected from a wide band of wavelengths to the maximum diffraction efficiency by integrating a transmission type diffractor and a mirror and by using only single angle adjustment thereof based on a wavelength of the incident light.

It is yet still another object of the present invention to provide a wavelength tunable spectrometer and wavelength tuning method which is capable of coupling a volume phase holographic grating and a mirror at a fixed angle such that a diffraction angle of transmitted light becomes the maximum efficiency angle and the light is converged onto a fixed output light path in consideration of an incidence angle of light incident into the volume phase holographic grating with high transmission efficiency over a wide band of wavelengths and a diffraction grid arrangement angle.

It is particularly noted that the present invention has the purpose of maintaining the highest precise spectrum analysis of incident light by diffracting light having a selected wavelength with the optimal diffraction efficiency, instead of selecting a particular wavelength from a light source having a plurality of different wavelengths, which is different from the purpose of generating a precise short wavelength light source.

### Technical Solution

To achieve the above objects, according to an aspect, the present invention provides a wavelength tunable spectrometer including: a transmission type diffractor which is rotatably arranged with the optimal incidence angle depending on a wavelength of external incident light and diffracts the incident light; a mirror which is fixed to the transmission type diffractor at a fixed angle and reflects light, which is transmitted and diffracted at an angle equal to an angle at which the light is incident into the transmission type diffractor, into a preset optical path; a driving unit which rotates the pole to rotate the transmission type diffractor and the mirror at an angle depending on a wavelength of the incident light; a condensing unit which condenses light output traveling via the mirror; and an observing unit which observes a spectrum of light condensed by the condensing unit.

Preferably, the observing unit is a slit or a camera.

Preferably, a diffraction angle of the transmission type diffractor is varied depending on a grid arrangement angle and the optimal incidence angle and a diffraction angle of the transmitted and diffracted light are determined based on the grid arrangement angle.

Preferably, the optimal incidence angle (θ) is calculated using an equation of θ=sin⁻¹(λ/2d), where λ is a wavelength of the incident light and d is a grid interval.

Preferably, the driving unit rotates the transmission type diffractor and the mirror around a point at which a diffraction axis extension of the transmission type diffractor intersects a reflection surface extension of the mirror.

Preferably, the transmission type diffractor includes a volume phase holographic grating.

According to another aspect, the present invention provides a wavelength tunable spectrometer including: an integrated diffracting unit including a mirror which reflects external incident light, and a transmission type diffractor which is arranged at a fixed angle with the mirror such that light reflected by the mirror has the optimal incidence angle on the basis of grid arrangement with respect to a wavelength of the external incidence light, and diffracts the incident light; a driving unit which rotates the integrated diffracting unit such that the incident light is incident into the transmission type diffractor at the optimal incidence angle depending on a wavelength of the incident light; and a slit or a camera which is disposed on a fixed light path traveling via the integrated diffracting unit.

According to still another aspect, the present invention provides a wavelength tuning method of a wavelength tunable spectrometer, including: an arrangement step of arranging a transmission type diffractor to transmit and diffract incident light based on a grid arrangement angle on an optical path and arranging a mirror to determine the optical path such that light output at a diffraction angle symmetrical to an incidence angle of the incident light to the transmission type diffractor is converged onto an output point, wherein the transmission type diffractor and the mirror are fixed to a side of a rotating pole; a wavelength tuning step of selecting a wavelength of a light source to be examined and rotating the pole such that incident light having the selected wavelength is incident into the transmission type diffractor at the optimal incidence angle; and an observing step of diffracting the incident light having the selected wavelength through the transmission type diffractor and the mirror and converting a spectrum of the incident light into an observable state through an observation means at the output point.

According to yet still another aspect, the present invention provides a wavelength tuning method of a wavelength tunable spectrometer, including: a diffracting unit arrangement step of arranging a wavelength tunable diffracting unit on an optical path, the wavelength tunable diffracting unit including a transmission type diffractor to transmit and diffract incident light based on a grid arrangement angle and a mirror which is disposed adjacent to the transmission type diffractor at a fixed angle to reflect the light diffracted by the transmission type diffractor; an analysis means arrangement step of arranging a spectrum analysis means on an output light path on which the wavelength tunable diffractor diffracts and reflects light having any wavelength incident at the optimal incidence angle; a calculation step in which a control unit receives wavelength information of an external light source for spectrum analysis through an interface and calculates the optimal incidence angle of light from the external light source into the transmission type diffractor using the wavelength information and grid interval information of the transmission type diffractor; a driving step in which the control unit controls a driving unit to rotate the wavelength tunable diffracting unit such that the light from the external light source is incident into the wavelength tunable diffracting unit at the calculated optimal incidence angle; and an observing step of observing a spectrum of the light from the external light source by means of the analysis means.

### Advantageous Effects

According to embodiments of the present invention, since a spectrum of incident light can be obtained with the optimal diffraction efficiency based on a wavelength of the incident light without motion of a camera for observation and replacement of a diffractor by rotatably arranging a transmission type diffractor to provide an incidence angle to provide the optimal efficiency for a selected wavelength of an external light source to be observed and arranging a mirror to provide light, which is changed in its diffraction angle depending on rotation of the transmission type diffractor and the wavelength of the incident light, on the same output light path irrespective of a change in the rotation of the transmission type diffractor and the wavelength of the incident light, it is possible to reduce a size of the spectrometer, product cost and possibility of failure.

In addition, since a diffraction grid arrangement angle of a transmission type diffractor can be selected to allow a design of a desired optical path with the optimal efficiency maintained, it is possible to achieve a high degree of freedom of design for a spectrometer and reduced volume of the spectrometer.

In addition, since diffraction efficiency of incident light selected from a wide band of wavelengths can be set to the maximum diffraction efficiency by integrating a transmission type diffractor and a mirror and by using only single angle adjustment thereof based on a wavelength of the incident light, it is possible to analyze incident light with the optimal diffraction efficiency without separate connection or manipulation.

In addition, a volume phase holographic grating can be coupled to a mirror at a fixed angle such that a diffraction angle of transmitted light becomes the maximum efficiency angle and the light is converged onto a fixed output light path in consideration of an incidence angle of light incident into the volume phase holographic grating with high transmission efficiency over a wide band of wavelengths and a diffraction grid arrangement angle, it is possible to reduce size and number of operation units, product costs and a volume of the system, and increase efficiency and precision of the system.

It is particularly noted that the present invention has the effect of maintaining the highest precise spectrum analysis of incident light by diffracting light having a selected wavelength with the optimal diffraction efficiency, instead of selecting a particular wavelength from a light source having a plurality of different wavelengths, which is different from the effect of generating a precise short wavelength light source.

### DESCRIPTION OF DRAWINGS

FIG. 1 is a conceptual view showing a configuration of a conventional spectrometer.

FIG. 2 is a conceptual view showing a configuration of a conventional wavelength tunable spectrometer.

FIG. 3 is a graph showing a dependency of diffraction efficiency of a reflection type diffractor on a wavelength.

FIG. 4 is a view showing a configuration of a transmission type diffractor applied to an embodiment of the present invention.

FIG. 5 is a view showing a configuration of a spectrometer according to an embodiment of the present invention.

FIGS. 6 and 7 are conceptual views for explaining operation of a diffraction unit according to an embodiment of the present invention.

FIG. 8 is a graph showing a dependency of diffraction efficiency of a diffraction unit on a wavelength according to an embodiment of the present invention.

FIG. 9 is a view showing a configuration of a spectrometer according to an embodiment of the present invention.

FIG. 10 is a configuration view for explaining a diffraction characteristic of a transmission type diffractor.

FIGS. 11 and 12 are configuration views showing an example optical path setting method.

FIG. 13 is an exemplary view showing a structure of a transmission type diffraction unit according to an embodiment of the present invention.

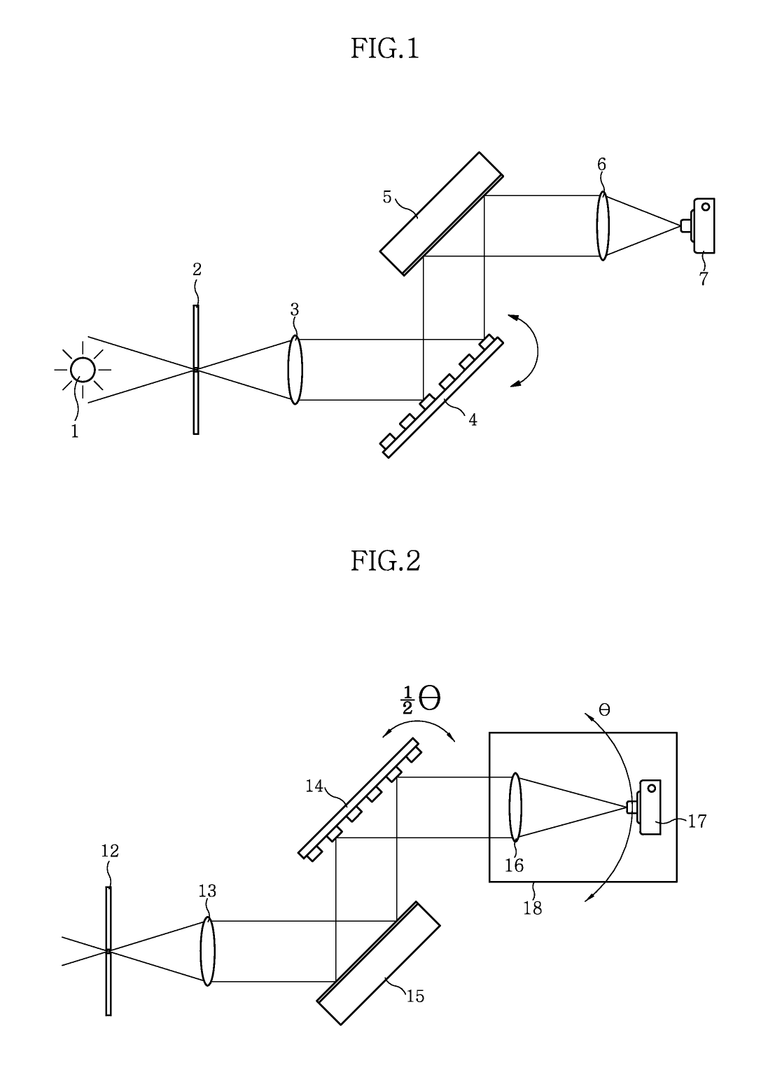

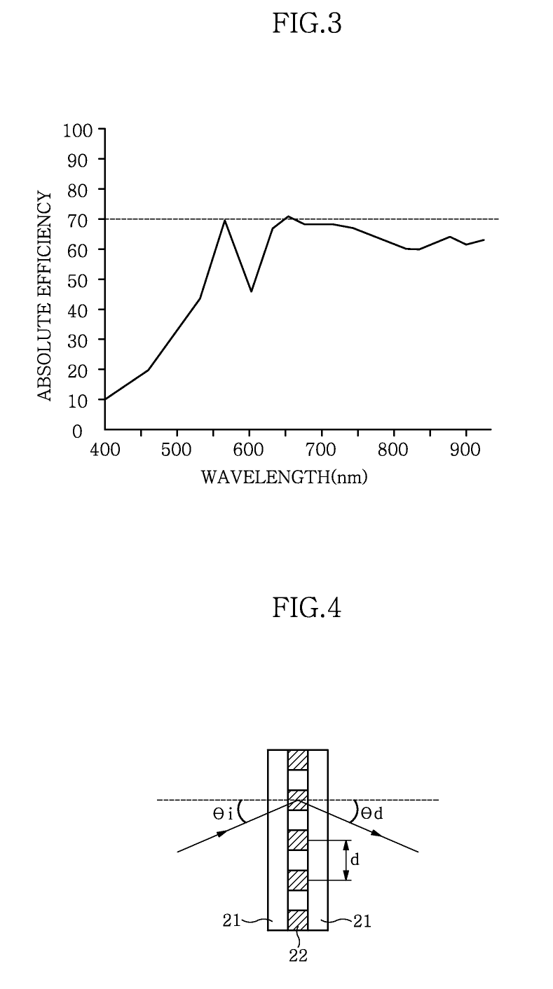

### MODE FOR INVENTION

The present invention relates to a novel configuration and an application of operation principle based on Korean Patent Application No. 10-2008-0005828, titled “wavelength tuning apparatus and method,” owned by the applicant. This patent application relates to a wavelength tunable laser which selects and resonates a particular wavelength of input laser light having a plurality of different wavelengths and outputs light having the selected wavelength precisely. However, it is noted that the present invention relates to a spectrometer which analyzes a spectrum of input light having a particular wavelength to detect properties of material transmitting the input light or material generating the particular wavelength, and more particularly, to a wavelength tunable spectrometer and wavelength tuning method which is capable of diffracting input light having a wavelength selected from a wide band of wavelengths with the highest diffraction efficiency irrespective of the selected wavelength to allow precise spectrum analysis and minimizing configuration and driving for such wavelength selection, and therefore the present invention is different in technical solution and operation principle from the above-mentioned patent application.

Hereinafter, preferred embodiments of the present invention will be described in detail with reference to the accompanying drawings.

FIG. 4 shows a configuration of a transmission type diffractor. The shown diffractor is a volume phase holographic grating (VPHG) which exhibits high transparency over most of a wavelength band having an optical meaning.

The shown diffractor includes two transparent front and rear transmission plates 21 and a grid 22 which is interposed therebetween and diffracts light having a particular wavelength in a propagation direction.

The diffractor has a property to diffract incident light to distort and transmit the light. In this distorted and transmitted light, light output with a reflection angle which is equal to an incidence angle of the light has the highest efficiency. That is, in the transmitted light, light output with a diffraction angle θ_{d} of the transmitted light which is symmetrical to an incidence angle θᵢ of incident light with respect to a virtual vertical line perpendicular to an incidence position of the diffractor (that is, a vertical line perpendicular to a diffraction axis) has the highest efficiency. Since the incidence angle providing the optimal efficiency and the transmitted light angle symmetrical the incidence angle are varied depending on an intended wavelength and a grid distance d, there is a need to obtain the optimal incidence angle and a transmitted light angle depending on a wavelength ? to generate light transmitted and diffracted with the optimal efficiency. This may be obtained according to the following equation 1.

λ=d(sin θᵢ+sin θ_{d}) Equation 1

That is, the optimal incidence angle θ_{I} and the diffraction angle θ_{d} of the transmitted light for an intended wavelength may be obtained using an equation of sin⁻¹ (λ/2d). Here, the incidence angle is equal to the diffraction angle of the transmitted light. On the one hand, it is noted that a baseline to obtain the incidence angle and the diffraction angle is based on a placement angle of the grid 22 and is shown to be a vertical line since the grid placement angle is perpendicular to the diffractor. Variation of the grid placement angle will be described later with reference to FIG. 10.

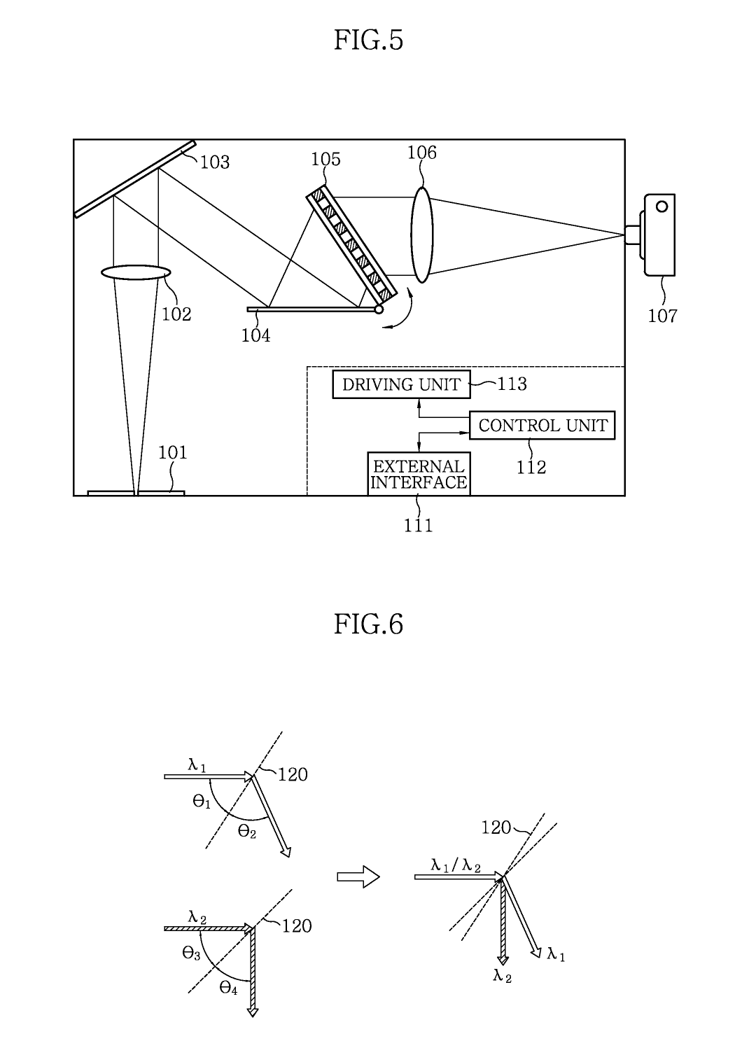

FIG. 5 shows a configuration of a wavelength tunable spectrometer according to an embodiment of the present invention. As shown, the spectrometer includes an input slit 101 which selects an external light source, a collimating lens 102 which makes light passing through the input slit 101 parallel, a mirror 103 which directs a path of the parallel light made by the collimating lens 102 to an integrated wavelength tunable structure including a transmission type diffractor 105 and an optical path setting mirror 104, a condensing lens 106 which condenses light diffracted by the integrated wavelength tunable structure, and a camera 107 which observes a spectrum of light condensed by the condensing lens 106. Although it is common that the camera 107 is used to observe a spectrum of incident light, it may be configured to output a spectrum through a slit.

Instead of the collimating lens 102 and the condensing lens 106, a concave mirror or other optical means may be employed for the same optical conversion. Accordingly, the collimating lens 102 may employ a collimating unit including a means for making light parallel and the condensing lens 106 may employ a condensing unit including a means for condensing light.

The spectrometer analyzes a spectrum of incident light having a particular wavelength diffracted by the diffractor 105 and accordingly has to provide high diffraction efficiency for the wavelength of the incident light.

The above-described transmission type diffractor 150 of FIG. 4 has a unique incidence angle providing the optimal diffraction efficiency depending on a wavelength and light on a path which is diffracted at an angle equal to the unique incidence angle of the light of the wavelength has the optimal diffraction efficiency. Accordingly, as shown in FIG. 6, incident light having a first wavelength λ₁ has the optimal diffraction efficiency at an incidence angle θ₁ which is equal to a diffracted light angle θ₂. On the other hand, incident light having a second wavelength λ₂ different from the first wavelength λ₁ has the optimal diffraction efficiency at an incidence angle θ₃ which is equal to a diffracted light angle θ₄.

Expressing these together, as shown in the right side of FIG. 6, it can be seen that an angle of the transmission type diffractor 120 has to be varied depending on a wavelength and a path of diffracted light is varied in such a case.

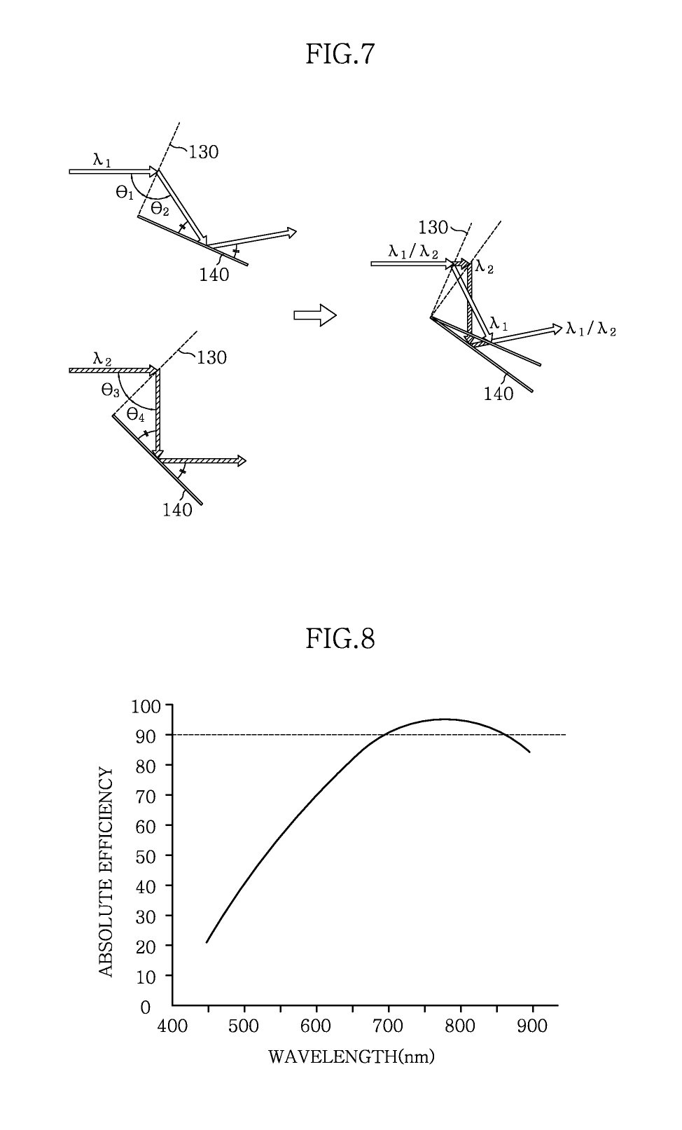

Accordingly, a light output point at which the diffracted light is observed is varied, thereby requiring an observation unit driving means as shown in FIG. 2. However, the integrated structure of the transmission type diffractor 105 and the mirror 104 according to the embodiment of the present invention exhibits a characteristic as shown in FIG. 7. That is, in an integrated structure of a transmission type diffractor 130 and a mirror 140, although the transmission type diffractor 130 and the mirror 140 have a fixed angle, a path of incident light is always equal to a path of diffracted and reflected light irrespective of a wavelength or rotation of the integrated structure.

That is, although light paths are different as the incidence angle θ₁ and the diffraction angle θ₂ of the incident light having the first wavelength λ₁ are different from the incidence angle θ₃ and the diffraction angle θ₄ of the incident light having the second wavelength λ₂, paths of light reflected by the mirror become eventually equal to each other and accordingly points at which output diffracted light arrive become equal to each other.

Accordingly, if only the integrated structure with the mirror 104 and the transmission type diffractor 105 fixed at the fixed angle in FIG. 5 is rotated to provide the optimal incidence angle for the wavelength of the incident light, the input light path and the output light path are always fixed, in which case the optimal incidence angle provides diffraction with the optimal efficiency. In this case, the mirror 104 and the transmission type diffractor 105 are rotated around a point at which a diffraction axis of the transmission type diffractor 105 intersects a reflection surface of the mirror 104 and they may not be fixed as their one ends contact with each other as shown in the figure.

On the one hand, an angle between the mirror 104 and the transmission type diffractor 105 may be determined to transfer optical paths of the optimal incidence angle and the diffraction angle for any wavelength of the incident light to a desired output point, and when the angle between the mirror 104 and the transmission type diffractor 105 is fixed so, the optimal diffraction efficiency can be automatically provided while maintaining the same optical path for any different wavelengths.

Accordingly, the configuration of FIG. 5 automatically follows a smooth optimal efficiency graph such as a diffraction efficiency graph as illustrated in FIG. 8.

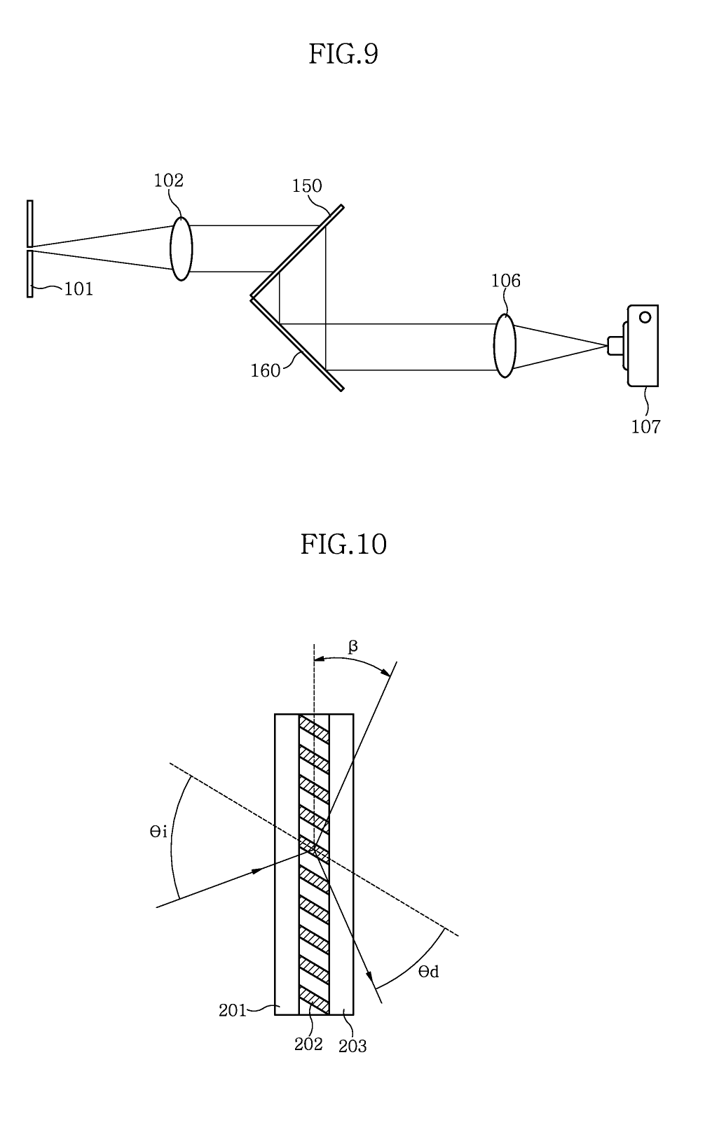

FIG. 9 shows reversed arrangement of the wavelength tunable diffraction unit including the transmission type diffractor and the mirror in the configuration of FIG. 5 on an optical path, where incident light travels through a mirror 160 via a transmission type diffractor 150.

FIG. 10 shows another configuration of the transmission type diffractor to change an optical path, where an arrangement angle of a grid 202 of a diffractor is inclined.

Although the above-mentioned arrangement angle of the mirror integrated with the transmission type diffractor is provided to set an optical path to converge the optimal efficiency diffraction angle output of a selected wavelength to an output point, since a reflection range of the mirror is limited and a shape of light or density of different wavelengths may be changed, it may be substantially difficult to set a desired optical path. In other words, although a variety of optical path settings may be required to configure a spectrometer, selection of optical paths is limited with only the mirror. To solve this problem, if a transmission type diffractor with a grid arrangement angle adjusted is used, the limitation on the optical path selection can be greatly alleviated.

As shown, when the grid is inclined by an angle β with respect to a longitudinal center line (dotted line) of the diffractor, an incidence angle θᵢ and a diffraction angle θ_{d} are calculated on the basis (inclined dotted line) of the grid arrangement angle. Even in this case, since the relationship of Equation 1 is equally established, a consideration may be only made on the basis of an inclined angle of the grid.

That is, if the diffraction angle θ_{d} is equal to the incidence angle θᵢ, then the diffraction angle θ_{d} becomes the optimal efficiency diffraction angle. Accordingly, the diffraction angle symmetrical to the incidence angle on the basis of the grid arrangement angle is utilized to determine an arrangement angle of the mirror for optical path setting and the existing formula can be utilized for selection of an incidence angle for wavelength selection.

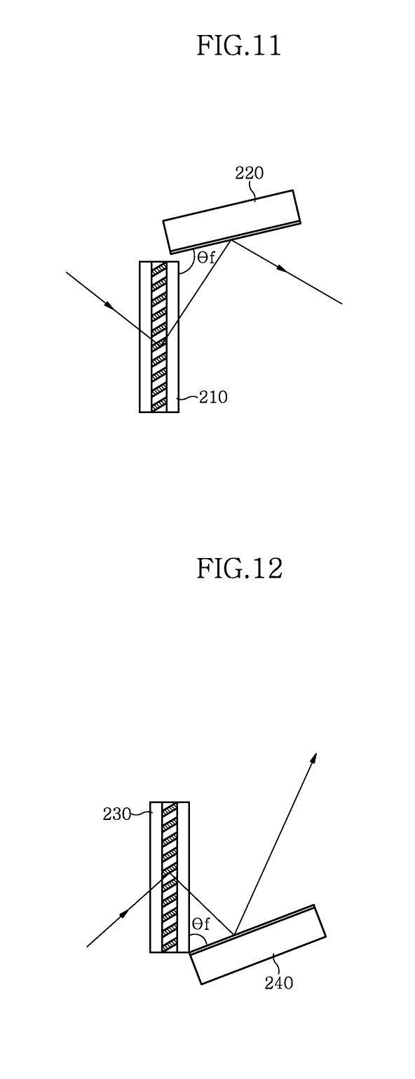

FIGS. 11 and 12 show how to set an optical path of a transmission type diffractor and a mirror. FIG. 11 shows a case where an angle θ_{f} between a transmission type diffractor 210 and a mirror 220 is an obtuse angle and FIG. 12 shows a case where an angle θ_{f} between a transmission type diffractor 230 and a mirror 240 is an acute angle. That is, with use of only a single element including a combination of the diffractor and the mirror with grid arrangement of the diffractor and an angle of the mirror adjusted, a high degree of freedom of design for an optical path over a wide range can be achieved while maintaining the optimal efficient diffraction.

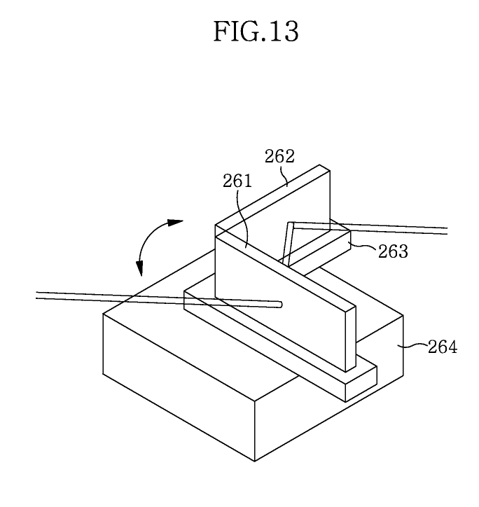

FIG. 13 shows practical arrangement and configuration of a transmission type diffractor and a mirror, where a transmission type diffractor 261 and a mirror 262 are fixed to a coupler 263 of a single body and the coupler 263 is rotated by a rotator 264. A rotation axis in the coupler 263 corresponds to a point at which a diffraction axis of the transmission type diffractor 261 intersects a reflection surface of the mirror 262 (a contact point in the shown configuration) and the rotator 264 has to be configured to be rotated precisely. In some cases, it is to be noted that a position of the rotation axis may be changed (incidence point of the diffractor, etc.).

An external interface 111 shown in FIG. 5 serves to obtain a user input to select a wavelength of incident light to be observed. When a wavelength value of the incident light input through the external interface 111 is obtained, a controller 112 receives this information, calculates the optimal incidence angle using Equation 1 and controls a driver 113 to rotate the integrated wavelength tunable diffraction unit including the transmission type diffractor 105 and the mirror 104 such that the diffraction unit has the obtained optimal incidence angle.

Although the coupler 263 may be in the form of a stage as shown, it may be in the form of fixing sides of the transmission type diffractor 261 and the mirror 262 to a pole for the purpose of decreasing an area.

While the present invention has been particularly shown and described with reference to exemplary embodiments thereof, it will be understood by those skilled in the art that various changes in form and details may be made therein without departing from the spirit and scope of the present invention as defined by the appended claims and equivalents thereof.

What is claimed is:

1. A wavelength tunable spectrometer comprising:
a transmission type diffractor which is rotatably arranged with the optimal incidence angle depending on a wavelength of external incident light and diffracts the incident light;
a mirror which is fixed to the transmission type diffractor at a fixed angle and reflects light, which is transmitted and diffracted at an angle equal to an angle at which the light is incident into the transmission type diffractor, into a preset optical path;
a pole which fixes sides of the transmission type diffractor and the mirror and acts as an integrated rotation axis;
a driving unit which rotates the pole to rotate the transmission type diffractor and the mirror at an angle depending on a wavelength of the incident light;
a condensing unit which condenses light output traveling via the mirror; and
an observing unit which observes a spectrum of light condensed by the condensing unit.

2. The wavelength tunable spectrometer according to claim 1, wherein the observing unit is a slit or a camera.

3. The wavelength tunable spectrometer according to claim 1, wherein a diffraction angle of the transmission type diffractor is varied depending on a grid arrangement angle and the optimal incidence angle and a diffraction angle of the transmitted and diffracted light are determined based on the grid arrangement angle.

4. The wavelength tunable spectrometer according to claim 3, wherein the optimal incidence angle (θ) is calculated using an equation of θ=sin⁻¹(λ/2d), where λ is a wavelength of the incident light and d is a grid interval.

5. The wavelength tunable spectrometer according to claim 1, further comprising an input slit which selectively inputs the external incident light, and a collimating unit which converts the incident light passing through the input slit into parallel light.

6. The wavelength tunable spectrometer according to claim 1, wherein the pole is rotated around a point at which a diffraction axis extension of the transmission type diffractor intersects a reflection surface extension of the mirror.

7. The wavelength tunable spectrometer according to claim 1, wherein the transmission type diffractor includes a volume phase holographic grating.

8. A wavelength tunable spectrometer comprising:
an integrated diffracting unit including a mirror which reflects external incident light, and a transmission type diffractor which is arranged at a fixed angle with the mirror such that light reflected by the mirror has the optimal incidence angle on the basis of grid arrangement with respect to a wavelength of the external incidence light, and diffracts the incident light;
a driving unit which rotates the integrated diffracting unit such that the incident light is incident into the transmission type diffractor at the optimal incidence angle depending on a wavelength of the incident light; and
a slit or a camera which is disposed on a fixed light path traveling via the integrated diffracting unit.

9. The wavelength tunable spectrometer according to claim 8, further comprising an input slit which selectively inputs the external incident light, and a collimating unit which converts the incident light passing through the input slit into parallel light.

10. The wavelength tunable spectrometer according to claim 8, wherein the transmission type diffractor includes a volume phase holographic grating.

11. The wavelength tunable spectrometer according to claim 8, wherein the optimal incidence angle (θ) is calculated using an equation of θ=sin⁻¹(λ/2d), where λ is a wavelength of the incident light and d is a grid interval.

12. The wavelength tunable spectrometer according to claim 1, further comprising a control unit which controls the driving unit with a wavelength and an angle determined according to an external control signal.

13. A wavelength tuning method of a wavelength tunable spectrometer, comprising:
an arrangement step of arranging a transmission type diffractor to transmit and diffract incident light based on a grid arrangement angle on an optical path and arranging a mirror to determine the optical path such that light output at a diffraction angle symmetrical to an incidence angle of the incident light to the transmission type diffractor is converged onto an output point, wherein the transmission type diffractor and the mirror are fixed to a side of a rotating pole;
a wavelength tuning step of selecting a wavelength of a light source to be examined and rotating the pole such that incident light having the selected wavelength is incident into the transmission type diffractor at the optimal incidence angle; and
an observing step of diffracting the incident light having the selected wavelength through the transmission type diffractor and the mirror and converting a spectrum of the incident light into an observable state through an observation means at the output point.

14. The wavelength tuning method according to claim 13, wherein the transmission type diffractor includes a volume phase holographic grating.

15. The wavelength tuning method according to claim 13, wherein the arrangement step includes arranging and fixing the transmission type diffractor and the mirror such that a point at which a diffraction axis of the transmission type diffractor intersects a reflection surface of the mirror becomes a rotation center of the pole.

16. The wavelength tuning method according to claim 8, wherein the wavelength tuning step includes calculating the optimal incidence angle using an equation of θ=sin⁻¹(λ/2d), where λ is an incidence angle of light from external light source into the transmission type diffractor, λ is a wavelength of the light from the external light source and d is a grid interval.

17. A wavelength tuning method of a wavelength tunable spectrometer, comprising:
a diffracting unit arrangement step of arranging a wavelength tunable diffracting unit on an optical path, the wavelength tunable diffracting unit including a transmission type diffractor to transmit and diffract incident light based on a grid arrangement angle and a mirror which is disposed adjacent to the transmission type diffractor at a fixed angle to reflect the light diffracted by the transmission type diffractor;
an analysis means arrangement step of arranging a spectrum analysis means on an output light path on which the wavelength tunable diffractor diffracts and reflects light having any wavelength incident at the optimal incidence angle;
a calculation step in which a control unit receives wavelength information of an external light source for spectrum analysis through an interface and calculates the optimal incidence angle of light from the external light source into the transmission type diffractor using the wavelength information and grid interval information of the transmission type diffractor;
a driving step in which the control unit controls a driving unit to rotate the wavelength tunable diffracting unit such that the light from the external light source is incident into the wavelength tunable diffracting unit at the calculated optimal incidence angle; and
an observing step of observing a spectrum of the light from the external light source by means of the analysis means.

18. The wavelength tuning method according to claim 17, wherein the diffracting unit arrangement step includes arranging the transmission type diffractor and the mirror in a reverse order on the basis of an optical path.

19. The wavelength tuning method according to claim 17, wherein the analysis means is a camera.

20. The wavelength tuning method according to claim 17, wherein the calculation step includes calculating the optimal incidence angle using an equation of θ=sin⁻¹(λ/2d), where λ is the optimal incidence angle, λ is a wavelength of the light from the external light source and d is a grid interval.

21. The wavelength tuning method according to claim 17, wherein the transmission type diffractor includes a volume phase holographic grating.
